(19) United States
(12) Patent Application Publication
(10) Pub. No.: US 2007/0283053 A1
(43) Pub. Date: Dec. 6, 2007

(54) Memory card with communication serial interface

(75) Inventors: Ming-Hui Liu, Yonghe City (TW); Li-Ho Yao, Taipei (TW); Chien-Hung Chen, Taipei (TW); Chih-Yih Yao, Taipei (TW)

Correspondence Address: POSZ LAW GROUP, PLC, 12040 SOUTH LAKES DRIVE, SUITE 101, RESTON, VA, 20191, US

(73) Assignee: STONE TECHNOLOGY INTERNATIONAL CO., LTD., Taipei (TW)

(21) Appl. No.: 11/637,033

(22) Filed: Dec. 12, 2006

(30) Foreign Application Priority Data
Jun. 2, 2006 (TW) 095119559

(51) Int. Cl. G06F 3/00

(52) U.S. Cl. 710/11

(57) ABSTRACT

A memory card is integrated with a communication serial interface integrated and a standard card interface of the memory card inside the memory card. The memory card provides two interfaces that share the same electrical contacts without changing the number of the electrical contacts of the conventional specification of the memory card.

### BACKGROUND OF THE INVENTION

1. Field of the Invention

The invention relates in general to a memory card, wherein the memory card is integrated with a communication serial interface and a standard card interface; wherein the memory card can be used for a device that is compatible to the standard card interface or used for a device that is compatible to the communication serial interface; wherein a shape, a size and a electrical contacts of the memory card are compatible to a specification of a present standard memory card.

2. Description of the Related Art

With the rapid development of technology, many electrical devices and portable devices are designed to provide more and more functions to facilitate users to use. For example conventional memory cards such as CF™ card or SD Memory Card provide more storage spaces and faster storage speed than before. Moreover, Secure Digital Association (SDA) further provides Mini-SD™ Card and Micro-SD™ Card with much smaller size, so as to reduce the size and also to facilitate users to carry.

However, there are plenty of interfaces with different specifications of electronic devices in the market. For example, the USB interface is popularly used for computers and peripherals in recent years. In addition, conventional portable storage devices for a digital camera or MP3 can be of various different kinds of memory cards. Hence an adapting device is required to transmit data. Therefore a dual interface memory card is brought to the market, which provides the memory card with the standard interface and a second interface to facilitate users to use.

With reference to FIG. 5, a perspective view of a conventional standard SD memory card is shown. A body 80 includes a plurality of electrical contacts 81 on one side. The electrical contacts 81 form a memory card standard interface 82 for the memory card to be used for a card reader with a compatible interface.

With reference to FIG. 6, a circuit block diagram of the conventional standard memory card shows functionality of a standard SD memory card. The body 80 as shown in FIG. 5 includes at least a memory card control circuit 83 and a memory module 84. The memory card control circuit 83 is connected with a card reader device having a compatible interface through the memory card standard interface 82.

With reference to FIG. 7, a conventional dual interface SD memory card mainly includes a housing 91 and a cap 92. The cap 92 is combined with the housing 91 to form a standard size of a SD memory card. The dual interface memory card includes a memory card standard interface 93 and a communication serial interface 94 at two ends of the housing 91 respectively. The memory card standard interface 93 allows the dual interface memory card to be used for a card reader with the compatible interface. The communication serial interface 94 can be connected to an USB port of electronic devices.

With reference to FIG. 8, an block circuit diagram of the conventional dual interface memory card includes a memory card control circuit 71, a reader control circuit 72, a logic control circuit 73 and a memory module 74 inside the hosing 91 as shown in FIG. 7. The memory card control circuit 71, the reader control circuit 72 and the logic control circuit 73 can be further integrated as a dual interface control circuit 70. The memory card control circuit 71 is connected to the memory card standard interface 93 through the logic control circuit 73. The reader control circuit 72 and the memory card control circuit 71 are coupled together via the logic control circuit 73 for storing data of the memory module 74. The reader control circuit 72 makes the dual interface memory card able to be directly used for an USB interface or for an IEEE 1394 interface of electronic devices with the communication serial interface 94. The communication serial interface 94 shown in the diagram is an USB interface.

The aforesaid conventional dual interface memory card can be used for the memory standard interface or the communication serial interface. However, the cap 92 and the electrical contacts of the communication serial interface 94 are not of the standard specification defined in the Secure Digital Association. Furthermore, mechanical structure designs of the reader devices of different brands are different. Therefore a mechanical structure compatible problem still needs to be improved.

### SUMMARY OF THE INVENTION

The present invention provides a memory card integrated with a communication serial interface and a standard card interface. The memory card can be used for a device that is compatible to the standard card interface or the communication serial interface. A shape, a size and electrical contacts of the memory card are compatible to a specification of a standard memory card.

The memory card includes a body and a communication serial interface.

The body with a shape and size compatible to a standard memory card has electrical contacts as the memory card standard interface that allows the memory card to be used by devices that support the memory card standard interface.

The communication serial interface is formed inside the body for the memory card to be used to electrical devices that support the communication serial interface. The memory card standard interface and the communication serial interface shares the same electrical contacts of the memory card body.

The memory card of the present invention uses the communication serial interface and its own memory card standard interface, so as to provide more flexibility and convenience than before for users to choose the memory card standard interface or the communication serial interface to be coupled to an electronic device. Most importantly, the communication serial interface and the memory card standard interface share the same electrical contacts without changing the electrical contacts of the conventional specification of the memory card. With this design feature, the memory card of the present invention not only can be used for conventional reader devices that support the communication serial interface and the memory card standard interface, but also can be compatible to the future reader devices that the single electrical contact supports both the communication serial interface and the memory card standard interface.

### BRIEF DESCRIPTION OF THE DRAWINGS

FIG. 1 is a perspective view of a first preferred embodiment of the present invention.

FIG. 2 is a circuit block diagram of the first preferred embodiment of the present invention.

FIG. 3A to FIG. 3D are detailed circuit diagrams of the first preferred embodiment of the present invention.

FIG. 4 is a circuit block diagram of the second preferred embodiment of the present invention.

FIG. 5 is a perspective view of a conventional standard memory card.

FIG. 6 is a circuit block diagram of a conventional standard memory card.

FIG. 7 is a perspective exploded view of a conventional dual interface memory card with a cap opened.

FIG. 8 is a circuit block diagram of a conventional dual interface memory card.

### DETAILED DESCRIPTION OF THE INVENTION

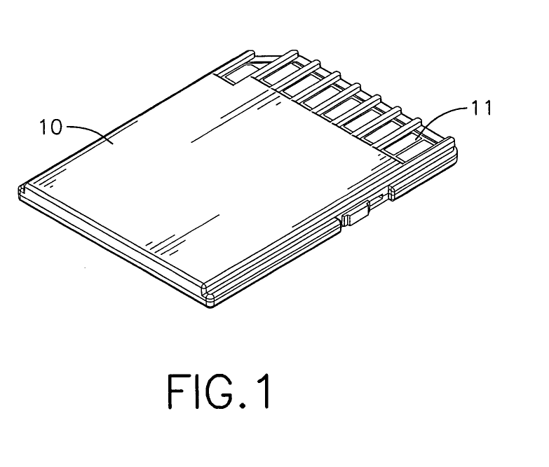

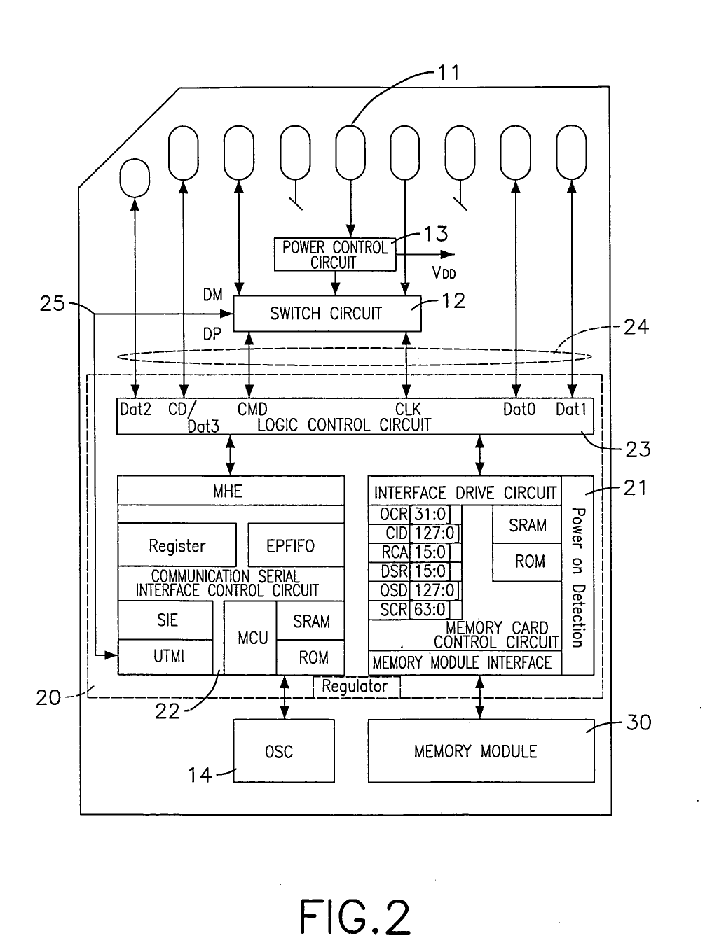

With reference to FIG. 1 and FIG. 2, a first preferred embodiment of the present invention includes a memory card body 10 and a circuit board inside the body 10. The shape and the size of the memory card body 10 are of the same specification as a standard memory card. The circuit board includes at least a dual interface control circuit 20, a memory module 30, a switch circuit 12 and a power control circuit 13. One end of the circuit is configured with multiple electrical contacts 11.

In this preferred embodiment of the present invention, the dual interface control circuit 20 is made up by a memory card control circuit 21, a communication serial interface control circuit 22 and a logic control circuit 23. The memory card control circuit 21 and the communication serial interface control circuit 22 are respectively coupled to the memory module 30 and an oscillator 14. Moreover, the memory card control circuit 21 and the communication serial interface control circuit 22 are both coupled to the logic control unit 23. The dual interface control circuit 20 further has a memory card standard interface 24 and a communication serial interface 25 respectively provided from the memory card control circuit 21 and the communication serial interface control circuit 22.

Further, the electrical contacts 11 form a communication port of the memory card. The communication port accomplishes an integration of the memory card standard interface 24 and the communication serial interface 25. The foregoing integration of the communication port means that the memory card standard interface 24 and the communication serial interface 25 share the same electrical contacts 11. A feasible technology is to make the switch circuit 12 switch the memory card standard interface 24 and the communication serial interface 25, so as to make the electrical contacts 11 switch from external connection signals to a respective control circuit of the dual interface control circuit 20. Moreover, a design of the switch circuit 12 can further comprises static electricity protection for the memory card.

Power for the memory card standard interface 24 and the communication serial interface 25 are common coupled to the same electrical contacts 11 via the switch circuit 12 and the power control circuit 13. The power control circuit 13 not only provides the power to the dual interface control circuit 20 and the memory module 30, but also depends on a predetermined voltage detection and definition range to control the switch circuit 12 to determine which control circuit of the dual interface control circuit 20 that the shared electrical contacts 11 will be coupled with.

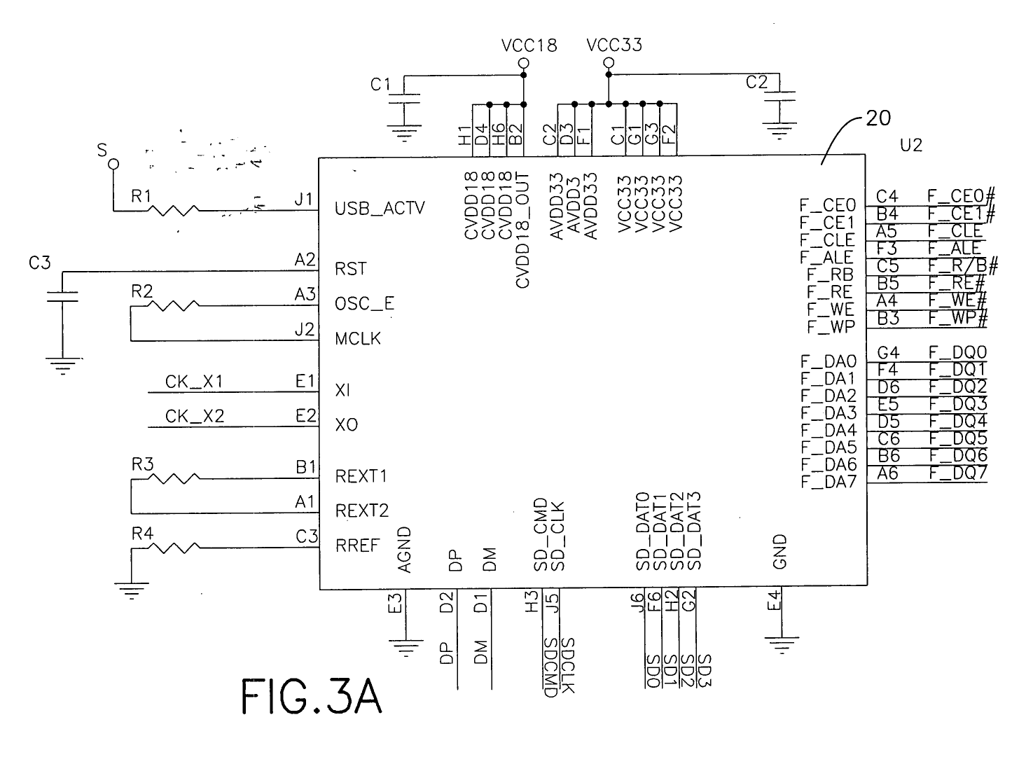

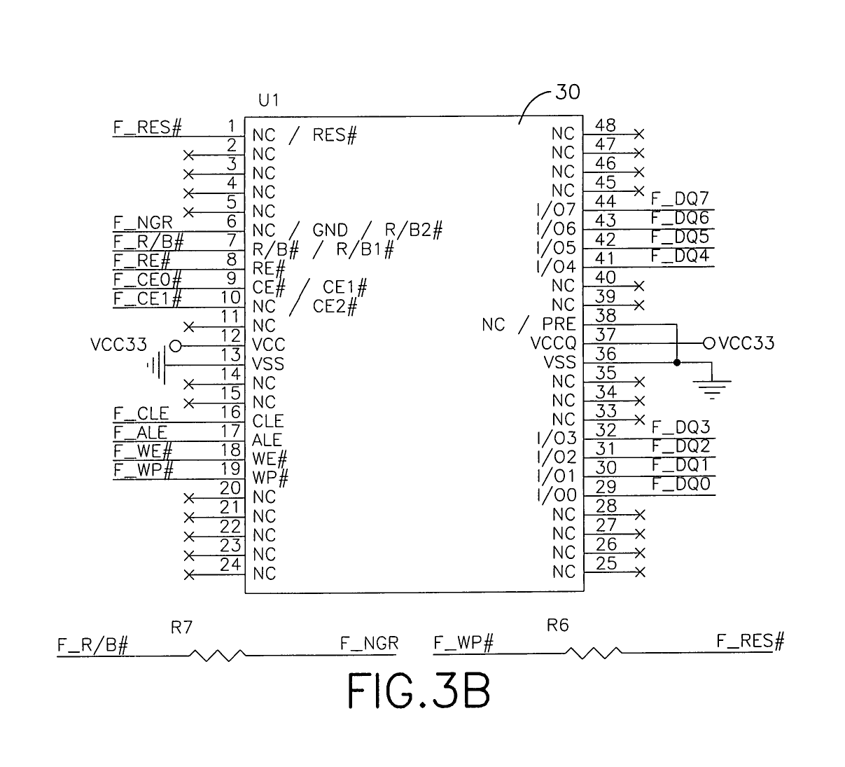

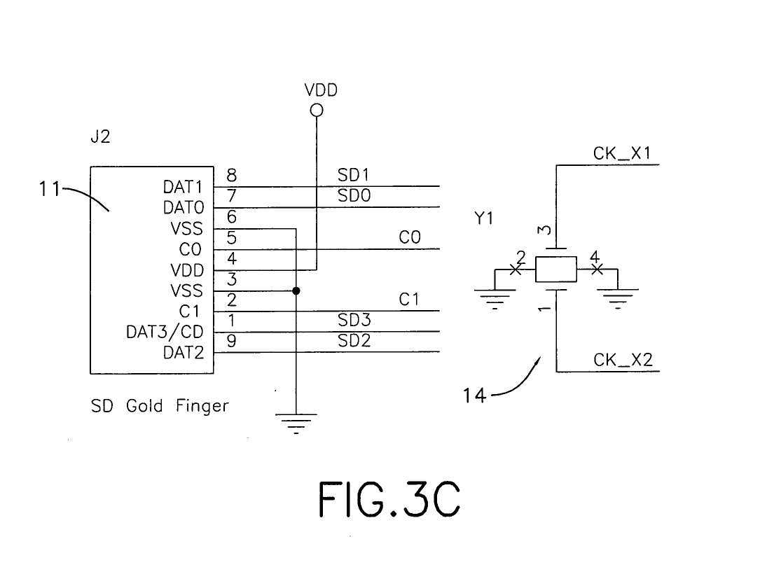

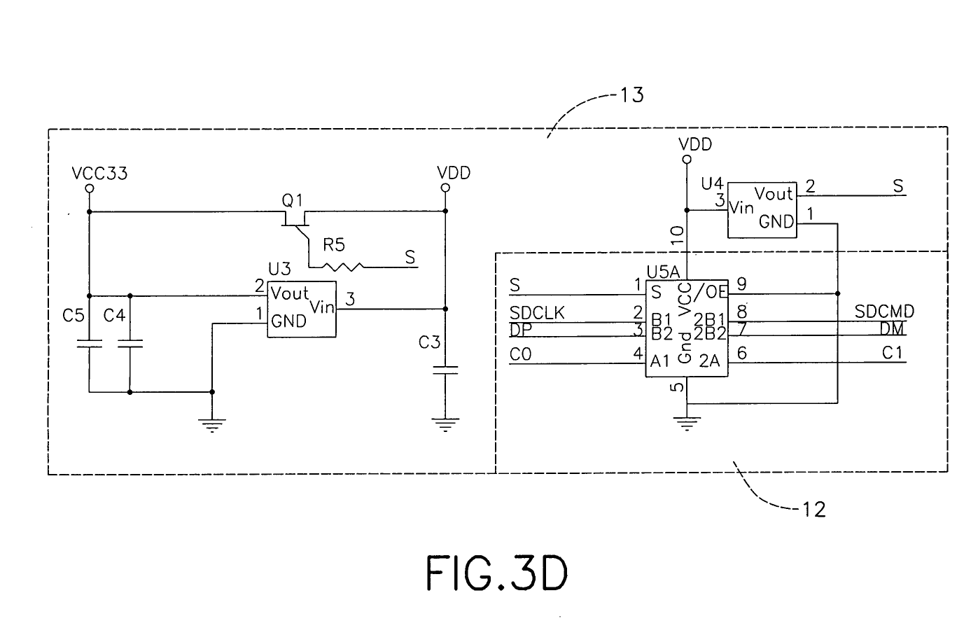

With reference to FIG. 3A to FIG. 3D, the first preferred embodiment of the present invention includes the dual interface control circuit 20, the memory module 30, the electrical contacts 11, the switch circuit 12, the power control circuit 13 and the oscillator 14.

The memory card standard interface 24 that the dual interface control circuit 20 supports is of SD memory card standard interface having corresponding signal pins of SD0 to SD3, SDCLK, SDCMD, and the like. The communication serial interface 25 that the dual interface control circuit 20 supports is of an USB interface having corresponding signal pins of DP and DM. The dual interface control circuit 20 is coupled to the memory module 30 by multiple pins.

Further, the pins of SD0 to SD3 of the memory card standard interface 24 are coupled to the electrical contacts 11, and the pins SDCLK and SDCMD are coupled to the switch circuit 12.

The pins of DP and DM of the communication serial interface 25 are coupled to the switch circuit 12. The power pins VCC33 of the dual interface control circuit 20 and the memory module 30 are coupled to power contacts VDD of the electrical contacts 11 via the power control circuit 13.

A power terminal VCC of the switch circuit 12 is coupled to the power contacts VDD of the electrical contacts 11.

The power control circuit 13 includes an electrical switch circuit, a voltage regulator circuit U3 and a voltage detection circuit U4. In this preferred embodiment, the electrical switch circuit is a field effect transistor (FET) Q1 having a source and a drain respectively coupled to the power contact VDD of the electrical contacts 11 and the power pin VCC33 of the memory card standard interface 24. A gate of the field effect transistor Q1 is coupled to the voltage detection circuit U4. An input terminal of the voltage detection circuit U4 is coupled to the power contact VDD, and an output terminal of the voltage detection circuit U4 is coupled to a control pin USB_ACTV of the dual interface control circuit 20. Moreover, an input terminal and an output terminal of the voltage regulator circuit U3 are respectively coupled to the power contact VDD of the electrical contacts 11 and the power pin VCC33 of the dual interface control circuit 20 and the memory module 30.

Operations of the aforesaid circuit are as follows.

A standard operating voltage of the SD memory standard interface is defined as 3.3 volts, and a standard operating voltage of the USB interface is defined as 5 volts. When the memory card of the present invention is plugged in an electronic device that supports the SD memory card, the electronic device provides power to the memory card. The power control circuit 13 of the memory card can detect that the power voltage of the electronic device is 3.3 volts with the power detection circuit U4. Then a corresponding control signal S, such as a low voltage level signal or a logic zero is generated. The control signal S will be sent to a pin 1 of the switch circuit 12 and the gate of the field effect transistor Q1 of the power control circuit 13. At this moment, the switch circuit 12 makes C0 and C1 of the electrical contacts 11 coupled to the pins SDCLK and SDCMD of the memory card standard interface 24 of the dual interface control circuit 20. The control signal S of the power control circuit 13 makes the field effect transistor Q1 conductive with a resistor R5, so as to make the power contacts VCC33 and VDD electrically connected to be 3.3 volts. Hence the dual interface control circuit 20 and the memory module 30 can operate with normal voltage supply.

On the other hand, when the memory card of the present invention is plugged in an interface connector of an electronic device that supports the USB interface, VDD is 5 volts. The control signal S output from the power detection circuit U4 of the power control circuit 13 changes to a high electric potential or a logic one. The switch circuit 12 then makes C0 and C1 of the electrical contacts 11 coupled to the pins DP and DM of the communication serial interface 25 of the dual interface control circuit 20. Then control signal S also turns off the field effect transistor Q1 of the power control circuit 13. The VDD with 5 volts voltage is then coupled to the power contact VCC33 via the voltage regulator circuit U3. The power contact VCC33 still acquires 3.3 volts to make the dual interface control circuit 20 and the memory module 30 operate with normal voltage supply.

Further, the control signal S generated by the power control circuit 13 can be coupled to the dual interface control circuit 20 to make the dual interface control circuit 20 control peripheral signal flow. The signal flow includes the control signal of the switch circuit 12.

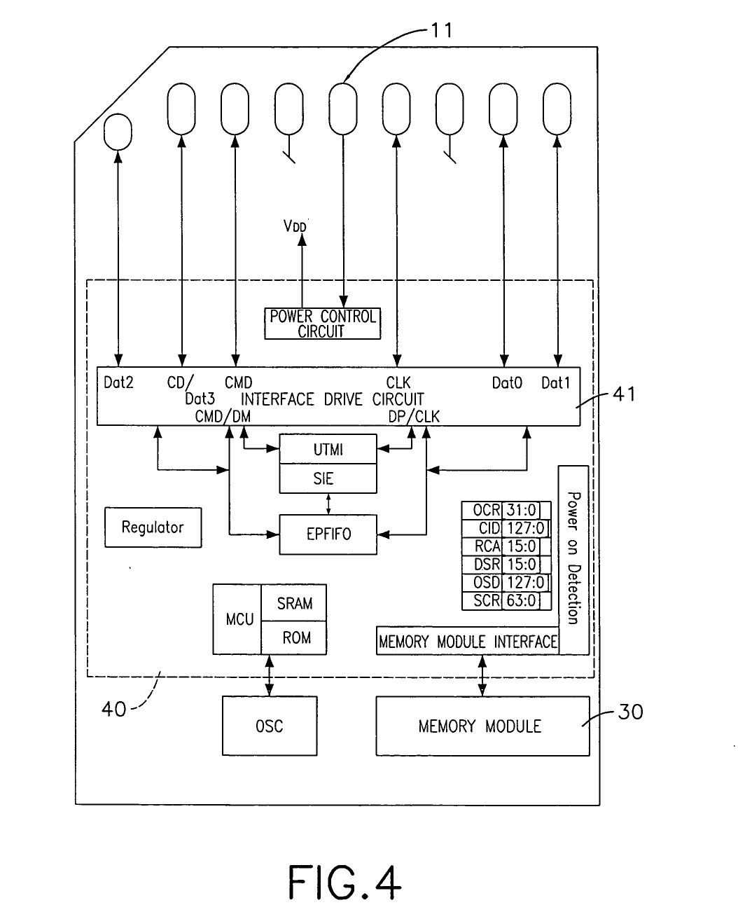

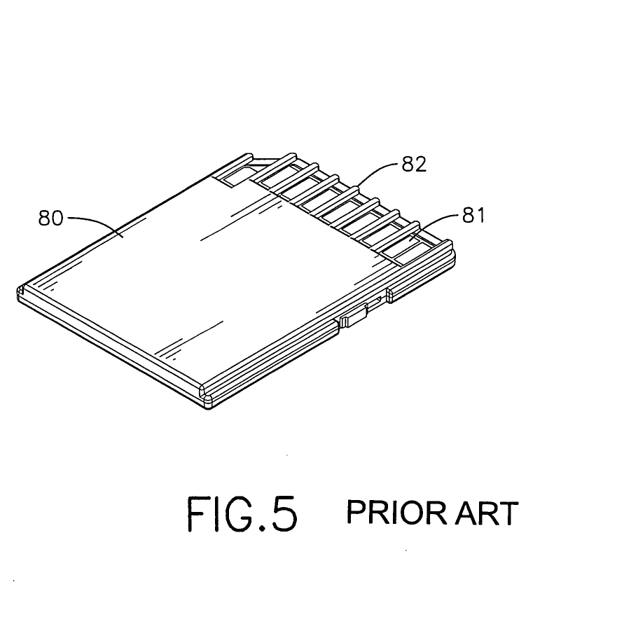

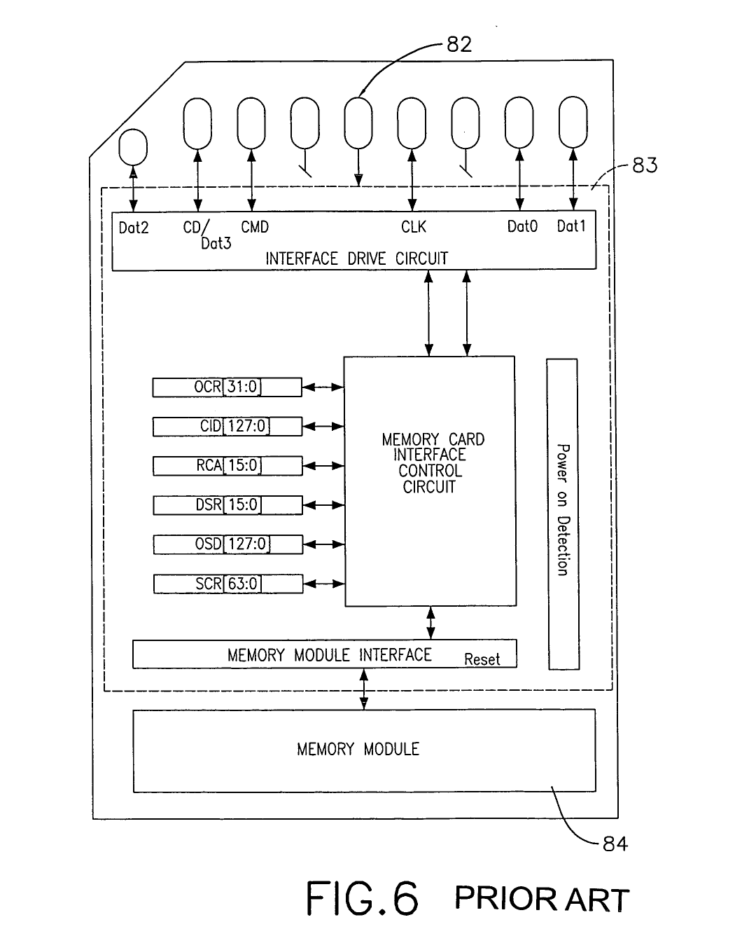

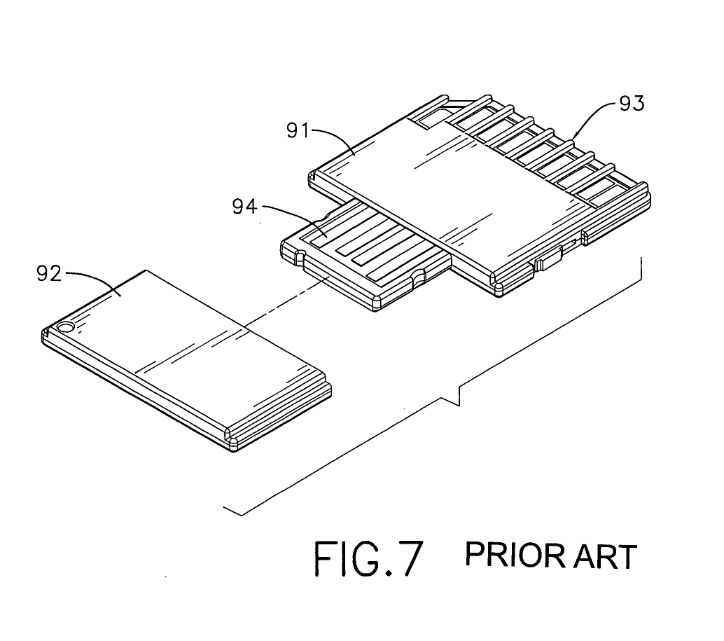

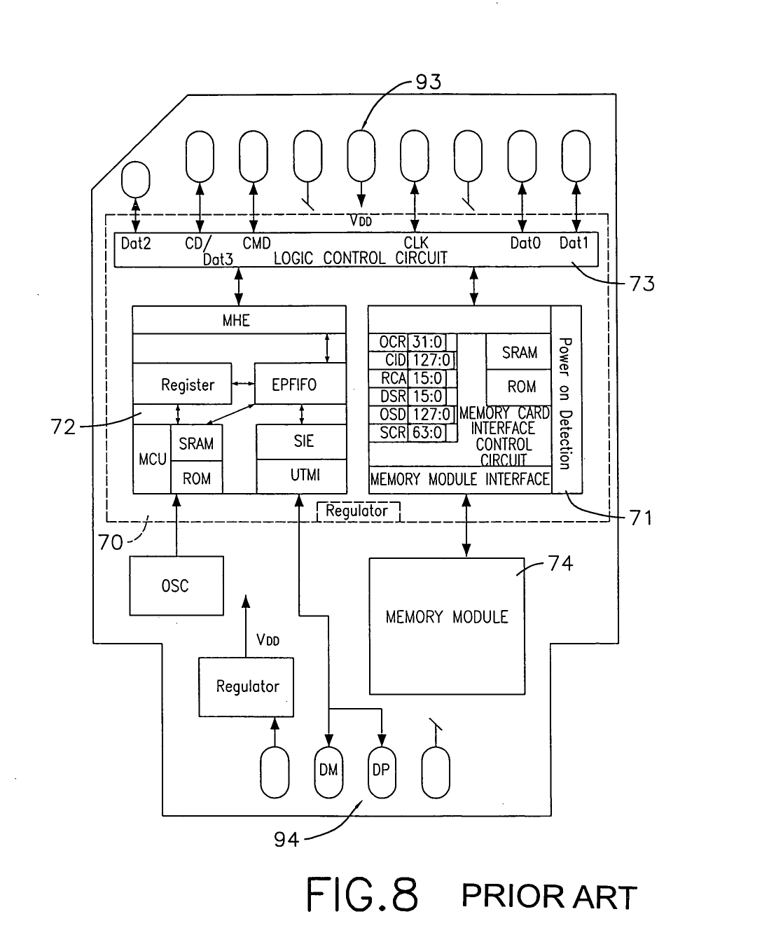

With reference to FIG. 4, the memory card of the present invention can further integrate the dual interface control circuit 20, the switch circuit 12 or the power control circuit 13 as an integration control module 40. When the memory card of the present invention is plugged to the electronic device, the power control circuit 13 can directly or indirectly control the switch circuit 12. The integration control module 40 is of a new design circuit module controlled by an interface drive circuit 41. An operating mode of the electrical contacts 11 of the memory card is then defined in a powered state that is when the integration control module 40 and the electronic device are in a handshake state.

When the memory card of the present invention is plugged to the electronic device which supports the USB interface, an USB interface specification is defined as follows: when an electronic device is coupled to a product such as a memory card of the present invention, the electronic device detects the product and then makes the voltage level of pins DP and DM of the communication serial interface of USB to a low level for 10 milliseconds.

When the memory card of the present invention is plugged to the electronic device which supports the SD memory card standard interface, an SD memory card standard interface specification is defined as follows: when an electronic device detects a product such as a memory card of the present invention, the electronic device should wait for a response of the product with a poll interval for 50 milliseconds after electrical contacts send out a clock signal CLK and also the electrical contacts send out an instruction CMD.

The integration control module 40 can make the communication port compatible to the interface that the plugged device supports in the device handshake status according to the USB interface specification and the memory card standard interface specification. The design of the present invention also can be used for a low voltage USB device.

It can be clearly understood from the above description that the present invention provides a memory card having the communication serial interface integrated with the standard card interface. The memory card can be used for the device that is compatible to the standard card interface of the memory card or used for the device that is compatible to the communication serial interface. The shape, size and the electrical contacts are also compatible to the specification of a conventional memory card. Therefore the integrated communication serial interface memory card includes more additional values and features of good utility than the conventional standard memory card, which provides better mechanical compatibility than the conventional dual interface memory card.

The memory card can be CF™ card, SD Memory Card, miniSD™ Card, microSD™ Card, MMC Card, MMCplus™ Card, MMCmobile™ Card, MMCmicro™ Card, Memory Stick, Memory Stick PRO, Memory Stick Duo, Memory Stick PRO Duo, Memory Stick Micro, xD-Picture Cards™ or T-Flash.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A memory card integrated with a communication serial interface, the memory card comprising:
a body with a shape and a size compatible to a standard memory card, the body having electrical contacts as a memory card standard interface that allows the memory card to be used by electronic devices supporting the memory card standard interface;
a communication serial interface formed inside the body for the memory card to be used to electronic devices that support the communication serial interface, wherein the memory card standard interface and the communication serial interface shares the same electrical contacts of the body.

2. The memory card as claimed in claim 1, the body comprising at least a dual interface control circuit, a memory module, a switch circuit and a power control circuit;
the dual interface control circuit comprising at least a memory card control circuit and a communication serial interface control circuit respectively for the memory card standard interface and the communication serial interface;
the switch circuit to switch the electrical contacts to connect to either the memory card standard interface or the communication serial interface.

3. The memory card as claimed in claim 2, wherein power supply of the communication serial interface and the memory card standard interface are coupled to the same electrical contacts.

4. The memory card as claimed in claim 3, wherein the power supply of the communication serial interface and the memory card standard interface are common coupled to the same electrical contacts by the switch circuit and power control circuit, wherein the power control circuit controls switching operations of the switch circuit according to a predetermined voltage detection and definition range, so as to determine that the whether the electrical contacts should coupled to the memory card standard interface or the communication serial interface.

5. The memory card as claimed in claim 1, the body comprising at least a dual interface control circuit and a memory module, wherein
the dual interface control circuit is made up by at least a memory card control circuit and a communication serial interface control circuit respectively for the memory card standard interface and the communication serial interface;
wherein an operating mode of the electrical contacts of the memory card is then defined in a powered state that an electronic device supplies power to the memory card, depending on a handshake status of the dual interface control circuit and the electronic device.

6. The memory card as claimed in claim 2, wherein signal pins SD0 to SD3 of the memory card standard interface of the dual interface control circuit are directly coupled to the electrical contacts, and pins SDCLK and SDCMD of the memory card standard interface are coupled to the switch circuit;
wherein pins of DP and DM of the communication serial interface are coupled to the switch circuit;
wherein power pins VCC33 of the dual interface control circuit are coupled to power contacts VDD of the power control circuit and the electrical contacts, wherein a power terminal VCC of the switch circuit is coupled to the power contacts VDD of the electrical contacts.

7. The memory card as claimed in claim 6, wherein the power control circuit further comprises an electrical switch circuit, a voltage regulator circuit U3 and a voltage detection circuit U4, wherein two terminals of the electrical switch circuit are respectively coupled to the power contact VDD of the electrical contacts and the power pin VCC33 of the dual interface control circuit, wherein a control terminal of the electrical switch circuit is coupled to an output terminal S of the voltage detection circuit U4, wherein an input terminal of the voltage detection circuit U4 is coupled to the power contact VDD, wherein an input terminal and an output terminal of the voltage regulator circuit U3 are respectively coupled to the power contact VDD of the electrical contacts and the power pin VCC33 of the dual interface control circuit.

8. The memory card as claimed in claim 7, wherein the electrical switch circuit is a field effect transistor.

9. The memory card as claimed in claim 1, wherein the communication serial interface is of USB of IEEE1394 wired communication interfaces.

10. The memory card as claimed in claim 1, wherein the memory card is a CF™ card, SD Memory Card, miniSD™ Card, microSD™ Card, MMC Card, MMCplus™ Card, MMCmobile™ Card, MMCmicro™ Card, Memory Stick, Memory Stick PRO, Memory Stick Duo, Memory Stick PRO Duo, Memory Stick Micro, xD-Picture Cards™ or T-Flash.
